(19) United States
(12) Patent Application Publication
(10) Pub. No.: US 2012/0141624 A1
(43) Pub. Date: Jun. 7, 2012

(54) SHAPING MOLD FOR PRODUCTS WITH CIRCULAR HOLE

(75) Inventors: Wen-peng GONG, Tu Cheng (TW); Xiao-ping WU, Tu Cheng (TW); Kun-hsueh CHIANG, Tu Cheng (TW)

(73) Assignee: Cheng Uei Precision Industry Co., LTD., Tu Cheng City (TW)

(21) Appl. No.: 12/960,352

(22) Filed: Dec. 3, 2010

(51) Int. Cl. B29C 33/76

(52) U.S. Cl. 425/329

(57) ABSTRACT

Disclosed is a shaping mold for products with a circular hole, comprising a male mold and a female mold corresponding thereto, forming a core cavity therebetween after the shaping mold is closed. A pin mold core and a female mold core capable of dipping into the core cavity are in the male mold and female mold respectively. A mating face of the pin mold core and the inner face of a square hole shaping portion of the female mold core compress with each other after the shaping mold is closed. With the limitation head and the limitation boards buckling up, the shaping mold of the present invention restricts the pin mold core not rotated in the core cavity to prevent dislocation of the mating face and the square hole shaping portion happening during the insert and shut off operation. Accordingly, the shaping accuracy of the products can be guaranteed.

### BACKGROUND OF THE INVENTION

1. Field of the Invention

The present invention generally relates to a molding, and more particularly, to a shaping mold for products with a circular hole.

2. Description of Prior Art

With the development of electronic technology, miniaturization for the portable electronic productions is a trend of development. Therefore, higher requirements to the accuracy and the quality of the shaping process for the products become essential. Please refer to FIG. 1, one end of the insulating base 100 protrudes and is formed a mating portion 103 which is ring column shaped. The insulating base 100 comprises a circular hole 101 penetrating the front, rear faces and the mating portion 103 of the insulating base 100. A plurality of square hole 102 connected with the circular hole 101 and at the side wall on the periphery of the circular hole 101. When the insulating base 100 is shaped in mold, a pin mold core (not shown) is needed to mold the circular hole 101. One end of a moving half mold (not shown) is needed to with one end of the pin mold core to shape the square hole 102.

However, a general pin mold core easily rotates when a product is shape molded and result in that the dislocation of ends of the pin mold core and the moving half mold for proceeding the insert and shut off operation. Therefore, the requirements of accuracy and the quality for the products cannot be satisfied.

### SUMMARY OF THE INVENTION

For solving the drawbacks of aforementioned prior art, the present invention provides a shaping mold for products with circular hole by high shaping accuracy of the products.

For realizing the aforesaid objective, the shaping mold for products with circular hole comprises a male mold and a female mold corresponding thereto. The male mold and the female mold form a core cavity therebetween after the shaping mold is closed. The male mold comprises a mounting hole, a limitation mold core and a pin mold core capable of slidably dipping into the core cavity. The female mold comprises a female mold core capable of slidably dipping into the core cavity. The limitation mold core is installed in the mounting hole. A circular slide hole is formed in the limitation mold core. Limitation boards are formed on the periphery of the circular slide hole at one end of the limitation mold core. The pin mold core is roughly column shaped and positioned in the circular slide hole. A mating face is formed on a side face of one end of the pin mold core and a limitation head is formed at the other end of the pin mold core to match with the limitation boards. A square hole shaping portion is formed at one end of the female mold core. The mating face and the inner face of the square hole shaping portion compress with each other after the shaping mold is closed.

As aforementioned, with the limitation head and the limitation boards buckling up, the shaping mold of the present invention restricts the pin mold core not rotated in the core cavity to prevent the dislocation of the mating face and the square hole shaping portion happening during the insert and shut off operation. Accordingly, the shaping accuracy of the products can be guaranteed.

### BRIEF DESCRIPTION OF THE DRAWINGS

FIG. 1 shows a three dimensional view diagram of an insulating base of an audio jack.

FIG. 2 shows an exploded assembly diagram of a shaping mold for products with circular hole according to one embodiment of the present invention.

FIG. 3 shows a three dimensional view diagram of a limitation mold of the shaping mold for products with circular hole according to the present invention.

FIG. 4 shows a three dimensional view diagram of a limitation mold core, a pin mold core and a female mold core of the shaping mold for products with circular hole in close status according to the present invention.

### DETAILED DESCRIPTION OF THE INVENTION

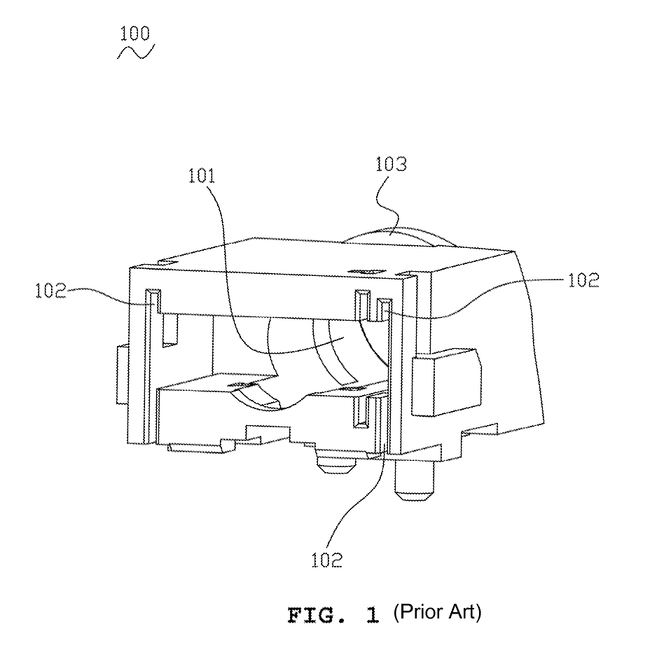

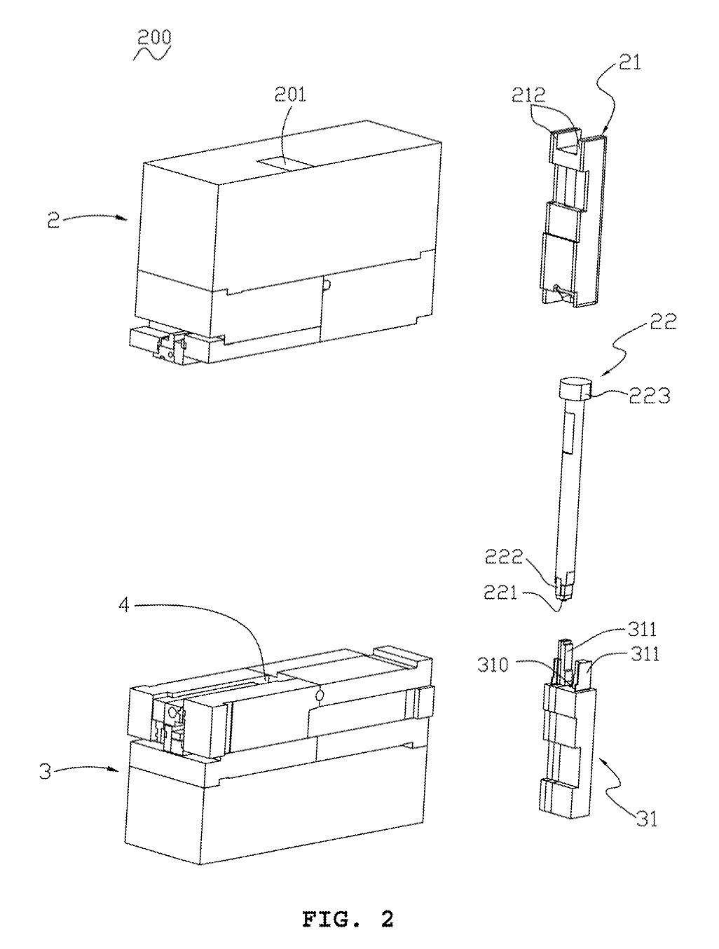

Please refer to FIG. 1, FIG. 2 and FIG. 3. In this embodiment, the shaping mold for products with circular hole is employed for shaping an insulating base 100 of an audio jack.

The shaping mold 200 for products with circular hole comprises a male mold 2 and a female mold 3 corresponding thereto. The male mold 2 and the female mold 3 form a core cavity 4 therebetween after the shaping mold 200 is closed. A limitation mold core 21 and a pin mold core 22 capable of slidably dipping into the core cavity 4 are installed in the male mold 2. A female mold core 31 capable of slidably dipping into the core cavity 4 is installed in the female mold 3.

Please continue to refer to FIG. 2 and FIG. 3. Concretely, a mounting hole 201 is formed in the male mold 2. A circular slide hole 210 is formed in the limitation mold core 21 for the pin mold core 22 to be slidably positioned therein. The limitation mold core 21 is installed in the mounting hole 201 and a mating-shaping portion 211 is formed at one end of the limitation mold core 21 jointing to the core cavity 4. The mating-shaping portion 211 corresponds to the mating portion 103 of the insulating base 100. Two limitation boards 212 are formed on the periphery of the circular slide hole 210 at one end of the limitation mold core 21. The pin mold core 22 is roughly column shaped and employed for shaping the circular hole 101 of the insulating base 100. A positioning protrusion 221 is formed at one end of the pin mold core 22. A mating face 222 is formed on a side face of the one end of the pin mold core 22 and a limitation head 223 is formed at the other end of the pin mold core 22 to match with the limitation boards 212. A positioning hole 310 for positioning the pin mold core 22 is formed at one end of the female mold core 31. A square hole shaping portion 311 is formed at the one end of the female mold core 31 for shaping the square hole 102.

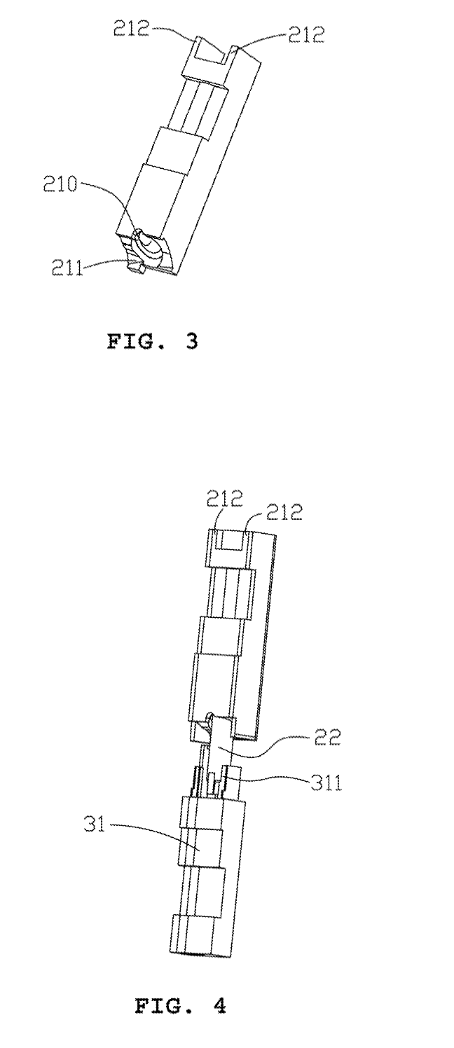

Please refer to FIG. 4. When the shaping mold 200 for products with circular hole is closed, the pin mold core is positioned in the circular slide hole 210 of the limitation mold core 21. The limitation head 223 and the limitation boards 212 buckle up. Then, one end of the pin mold core 22 slidably dips into the core cavity 4 and the square hole shaping portion 311 of the female mold core 31 also slidably dips into the core cavity 4. The positioning protrusion 221 is located in the positioning hole 310. The mating face 222 and the inner face of the square hole shaping portion 311 compress with each other.

As aforementioned, with the limitation head 223 and the limitation boards 212 buckling up, the shaping mold 200 of the present invention can restrict the pin mold core 22 not rotated in the core cavity 4 to prevent the dislocation of the mating face 222 and the square hole shaping portion 311 happening during the insert and shut off operation. Accordingly, the shaping accuracy of the products can be guaranteed.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A shaping mold for products with a circular hole, comprising:
a male mold, comprising a mounting hole;
a female mold, corresponding to the male mold, and a core cavity is formed between the male mold and the female mold after the shaping mold is closed;
a limitation mold core, installed in the mounting hole of the male mold, and a circular slide hole is formed in the limitation mold core, and limitation boards are formed on the periphery of the circular slide hole at one end of the limitation mold core;
a pin mold core, installed on the male mold and slidably positioned in the circular slide hole, and slidably dipping into the core cavity, and a mating face is formed on a side face of one end of the pin mold core and a limitation head is formed at the other end of the pin mold core to match with the limitation boards; and
a female mold core, installed in the female mold and slidably dipping into the core cavity, and a square hole shaping portion is formed at one end of the female mold core, and the mating face and the inner face of the square hole shaping portion compress with each other after the shaping mold is closed.

2. The shaping mold for products with a circular hole of claim 1, wherein a positioning protrusion is formed at one end of the pin mold core, and a positioning hole for positioning the pin mold core is formed at one end of the female mold core, and the positioning protrusion is located in the positioning hole after the shaping mold is closed.

3. The shaping mold for products with a circular hole of claim 1, wherein a mating-shaping portion is formed at one end of the limitation mold core jointing to the core cavity.
